(19) United States
(12) Patent Application Publication
(10) Pub. No.: US 2014/0118881 A1
(43) Pub. Date: May 1, 2014

(54) CAPACITOR AND METHOD OF MANUFACTURING THE SAME

(71) Applicant: SAMSUNG ELECTRO-MECHANICS CO., LTD., Suwon (KR)

(72) Inventors: Tae Yoon KIM, Suwon (KR); Young-Sik KANG, Suwon (KR); Sung Min CHO, Suwon (KR); Yeong Gyu LEE, Suwon (KR)

(73) Assignee: SAMSUNG ELECTRO-MECHANICS CO., LTD., Suwon (KR)

(21) Appl. No.: 13/740,717

(22) Filed: Jan. 14, 2013

(30) Foreign Application Priority Data
Oct. 29, 2012 (KR) 10-2012-0120723

(51) Int. Cl. H01G 4/38; H01G 13/00; H01G 4/008

(52) U.S. Cl. CPC H01G 4/385; H01G 4/008; H01G 13/00
USPC 361/301.4; 228/179.1; 228/172

(57) ABSTRACT

There is provided a capacitor, including: a first substrate: a first capacitance generation part formed on the first substrate; a protective layer formed on the first capacitance generation part; a second capacitance generation part formed on the protective layer; and a second substrate formed on the second capacitance generation part.

### CROSS-REFERENCE TO RELATED APPLICATIONS

This application claims the priority of Korean Patent Application No. 10-2012-0120723 filed on Oct. 29, 2012, in the Korean Intellectual Property Office, the disclosure of which is incorporated herein by reference.

### BACKGROUND OF THE INVENTION

1. Field of the Invention

The present invention relates to a capacitor and a method of manufacturing the same.

2. Description of the Related Art

As the market for mobile communications devices and portable electronic devices has recently expanded, capacitors having an ultrasmall size and a high capacitance are in increasing demand. For this reason, research into multilayer ceramic capacitors (MLCCs) having a small size and high capacitance has been actively undertaken. However, existing multilayer ceramic capacitors are composed of several tens to several hundreds of ceramic-electrode layers, and thus, there is a limit in reducing the thickness thereof.

In order to solve this defect, a thin film silicon capacitor in which a plurality of metal-insulator-metal (MIM) layers are stacked to thereby secure high capacitance even with relatively thin MIM layers has been developed in recent years.

However, since the plurality of MIM layers are stacked, electrical fields between an upper electrode and a lower electrode may be concentrated on particular regions, due to accumulated surface roughness. In this case, current leakage is likely to occur. Moreover, the MIM layers below are subjected to repetitive heat treatments during the processing procedure, resulting in deterioration of capacitor electrode and dielectric layer characteristics.

Related Art Document below discloses a thin film capacitor in which interior cracking or delamination is suppressed, but fails to solve the defect caused by stacking a plurality of MIM layers on a single substrate.

### RELATED ART DOCUMENT

US Patent Application Publication No. 2011-0128669

### SUMMARY OF THE INVENTION

An aspect of the present invention provides a capacitor capable of preventing current leakage due to an accumulation of surface roughness caused by stacking a plurality of metal-insulator-metal (MIM) layers, and a method of manufacturing the same.

Another aspect of the present invention also provides a capacitor capable of preventing deterioration in electrode layer and dielectric layer characteristics due to repetitive heat treatments, and a method of manufacturing the same.

According to an aspect of the present invention, there is provided a capacitor, including: a first substrate: a first capacitance generation part formed on the first substrate; a protective layer formed on the first capacitance generation part; a second capacitance generation part formed on the protective layer; and a second substrate formed on the second capacitance generation part.

The first capacitance generation part may include a first lower electrode, a first dielectric layer, and a first upper electrode.

The second capacitance generation part may include a second lower electrode, a second dielectric layer, and a second upper electrode.

The first and second lower electrodes and the first and second electrodes may include at least one of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

The first and second dielectric layers may include at least one of lead zirconium titanates (PZT, PLZT, PNZT), barium titanate (BTO), barium strontium titanate (BST), strontium titanium oxide (STO), lead titanate (PTO), antimony tin oxide (ATO), titanium dioxide (TiO₂), and tantalum oxide (Ta₂O₅), aluminum oxide (Al₂O₃), niobium oxide (Nb₂O₅), silicon nitride (Si₃N₄), and silicon dioxide (SiO₂).

The capacitor may further include a third capacitance part formed on the second substrate.

The capacitor may further include a third substrate formed on the third capacitance generation part.

The capacitor may further include: first electrode pad parts electrically connected to the first capacitance generation part; and second electrode pad parts electrically connected to the second capacitance generation part, wherein the first electrode pad parts and the second electrode pad parts are electrically connected to each other.

The first electrode pad parts may include: a first connection part electrically connected to one of the first lower electrode and the first upper electrode; and a second connection part electrically connected to the other of the first lower electrode and the first upper electrode, not electrically connected to the first connection part.

The second electrode pad parts may include: a third connection part electrically connected to one of the second lower electrode and the second upper electrode; and a fourth connection part electrically connected to the other of the second lower electrode and the second upper electrode, not electrically connected to the third connection part.

The second electrode pad parts may be formed on the first electrode pad parts.

The first electrode pad parts and the second electrode pad parts may be formed on the first substrate.

According to another aspect of the present invention, there is provided a method of manufacturing a capacitor, the method including: preparing a first structure body including a first capacitance generation part, a first protective layer, and first electrode pad parts; preparing a second structure body including a second capacitance generation part, a second protective layer, and second electrode pad parts; and binding the second structure body to an upper surface of the first structure body by disposing the first electrode pad parts and the second electrode pad parts in positions corresponding to each other.

The preparing of the first structure body may include: preparing a first substrate; forming a first capacitance generation part on one surface of the first substrate; forming a first protective layer on an upper surface of the first capacitance generation part; and forming first electrode pad parts on one surface of the first substrate.

The preparing of the second structure body may include: preparing a second substrate including depressed regions; forming a second capacitance generation part on one surface of the second substrate; forming a second protective layer on an upper surface of the second capacitance generation part; and forming second electrode pad parts in the depressed regions of the second substrate.

Here, in the binding of the second structure body to the upper surface of the first structure body, the first electrode pad parts and the second electrode pad parts may be electrically connected to each other.

The method may further include grinding the second electrode pad parts formed in the depressed regions.

The method may further include forming a third capacitance generation part, a third protective layer, and third electrode pad parts on a ground surface.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a capacitor according to an embodiment of the present invention;

FIGS. 2A and 2B are exploded views of the capacitor according to the embodiment of the present invention;

FIGS. 3A to 3E are views illustrating a method of manufacturing a first structure body according to another embodiment of the present invention;

FIGS. 4A to 4E are views illustrating a method of manufacturing a second structure body according to another embodiment of the present invention;

FIGS. 5A and 5B are views illustrating a method of manufacturing a capacitor according to another embodiment of the present invention; and

FIGS. 6A to 6E are views illustrating a method of manufacturing a capacitor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

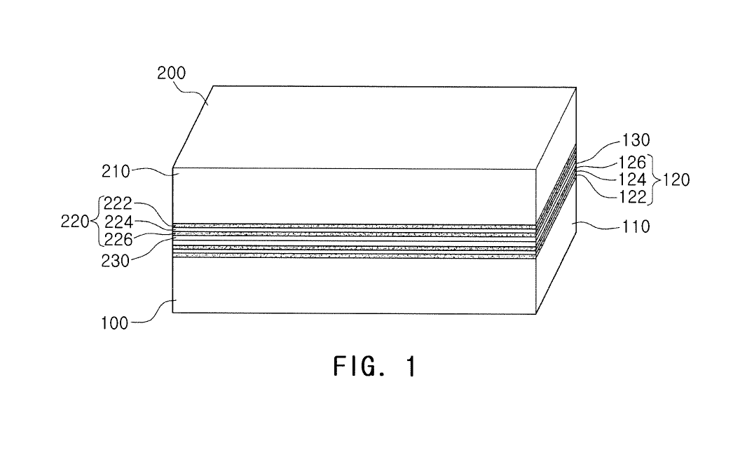

FIG. 1 is a perspective view of a capacitor according to an embodiment of the present invention.

Referring to FIG. 1, a capacitor according to the present embodiment of the invention may include a first structure body 100 and a second structure body 200.

The capacitor may be formed by binding one surface of the first structure body 100 to one surface of the second structure body 200.

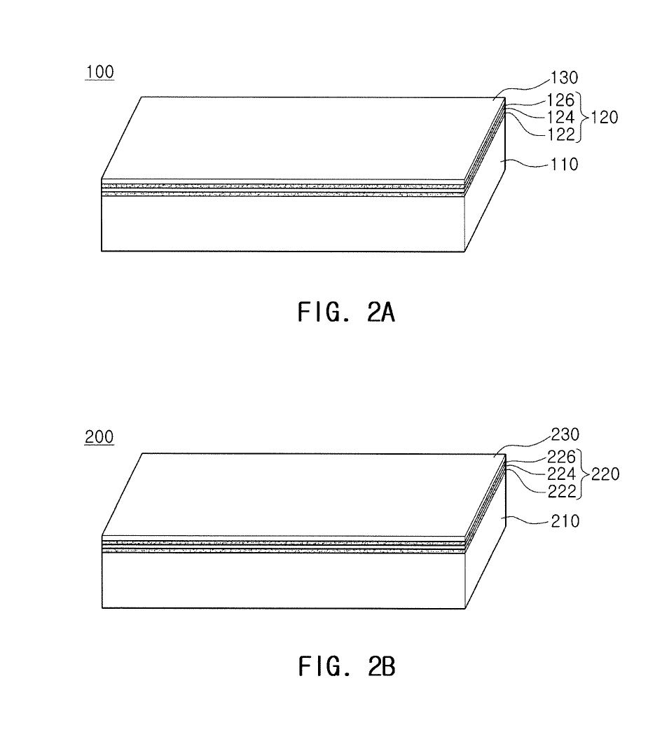

FIGS. 2A and 2B are exploded views of the capacitor according to the embodiment of the present invention. FIG. 2A shows the first structure body 100 according to the embodiment of the present invention. FIG. 2B shows the second structure body 200 according to the embodiment of the present invention.

Referring to FIG. 2A, the first structure body 100 may include a first substrate 110, a first capacitance generation part 120, and a first protective layer 130.

The first substrate 110 may be a silicon or polymer complex-based substrate on which an insulating layer is formed. For example, the polymer complex-based substrate maybe formed of a polyimide or an epoxy that is often used for a printed circuit board.

The first capacitance generation part 120 may generate capacitance. The first capacitance generation part 120 may include a first lower electrode 122, a first dielectric layer 124, and a first upper electrode 126.

The first lower electrode 122 may be formed on one surface of the first substrate 110. The first dielectric layer 124 may be formed on one surface of the first lower electrode 122. The first upper electrode 126 maybe formed on one surface of the first dielectric layer 124.

The first lower electrode 122 and the first upper electrode 126 may be formed of at least one metal selected from the group consisting of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

The first dielectric layer 124 may include at least one of lead zirconium titanate and materials within the same class (PZT, PLZT, PNZT, or the like), barium titanate (BTO), barium strontium titanate (BST), strontium titanium oxide (STO), lead titanate (PTO), antimony tin oxide (ATO), titanium dioxide (TiO₂), tantalum oxide (Ta₂O₅), aluminum oxide (Al₂O₃), niobium oxide (Nb₂O₅), silicon nitride (Si₃N₄), and silicon dioxide (SiO₂).

The first dielectric layer 124 may be formed by physical vapor deposition (PVD) such as sputtering or the like, chemical vapor deposition (CVD), atomic layer deposition (ALD), a chemical solution deposition (CSD) using sol-gel, or the like.

The first protective layer 130 may be formed on one surface of the capacitance generation part 120. The first protective layer 130 may be an inorganic protective layer of SiNₓ, SiOₓ, TiOₓ, SiON, AlOₓ, or the like, or an organic protective layer of polyimide resin, epoxy resin, or the like.

As shown in FIG. 2A, the first capacitance generation part 120 may be formed to have a shape corresponding to one surface of the first substrate 110. Also, the first protective layer 130 may be formed to have a shape corresponding to one surface of the first substrate 110.

Referring to FIG. 2B, the second structure body 200 may include a second substrate 210, a second capacitance generation part 220, and a second protective layer 230.

The second substrate 210 may be a silicon or polymer complex-based substrate on which an insulating layer is formed. For example, the polymer complex-based substrate may be formed of a polyimide or an epoxy that is often used for a printed circuit board.

The second capacitance generation part 220 may generate capacitance. The second capacitance generation part 220 may include a second lower electrode 222, a second dielectric layer 224, and a second upper electrode 226.

The second lower electrode 222 may be formed on one surface of the second substrate 210. The second dielectric layer 224 may be formed on one surface of the second lower electrode 222. The second upper electrode 226 may be formed on one surface of the second dielectric layer 224.

The second lower electrode 222 and the second upper electrode 226 may be formed of at least one metal selected from the group consisting of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

The second dielectric layer 224 may include at least one of lead zirconium titanate and materials within the same class (PZT, PLZT, PNZT, or the like), barium titanate (BTO), barium strontium titanate (BST), strontium titanium oxide (STO), lead titanate (PTO), antimony tin oxide (ATO), titanium dioxide (TiO₂), and tantalum oxide (Ta₂O₅), aluminum oxide (Al₂O₃), niobium oxide (Nb₂O₅), silicon nitride (Si₃N₄), and silicon dioxide (SiO₂).

The second dielectric layer 224 may be formed by physical vapor deposition (PVD) such as sputtering or the like, chemical vapor deposition (CVD), atomic layer deposition (ALD), a chemical solution deposition (CSD) using sol-gel, or the like.

The second protective layer 230 may be formed on one surface of the second capacitance generation part 220. The second protective layer 230 may be an inorganic protective layer of SiNₓ, SiOₓ, TiOₓ, SiON, AlOₓ, or the like, or an organic protective layer of polyimide resin, epoxy resin, or the like.

As shown in FIG. 2B, the second capacitance generation part 220 may be formed to have a shape corresponding to one surface of the second substrate 210. Also, the second protective layer 230 may be formed to have a shape corresponding to one surface of the second substrate 210.

Referring to FIG. 1 to FIG. 2B, the capacitor according to the present embodiment of the invention may be formed by binding the second structure body 200 to one surface of the first structure body 100. For example, the first structure body and the second structure body may be bonded to each other by binding the second protective layer 230 included in the second structure body to an upper surface of the first protective layer 130 included in the first structure body.

Meanwhile, the first protective layer 130 of the first structure body 100 and the second protective layer 230 of the second structure body 200 may be bonded to each other, and thus integrated with each other. Meanwhile, the first structure body 100 may include the first protective layer 130, but the second structure body 200 may not include the second protective layer 230. Alternatively, the second structure body 200 may include the second protective layer 230, but the first structure body 100 may not include the first protective layer 130.

According to the present embodiment of the invention, the first capacitance generation part 120 and the second capacitance generation part 220 may be formed on separate substrates, respectively.

In the case of the thin film silicon capacitor in which a plurality of MIM layers are stacked on a single substrate, surface roughness is accumulated since the MIM layers are stacked, and thus current leakage is likely to occur in a particular region.

Whereas, in the capacitor according to the present embodiment of the invention, surface roughness thereof is relatively less increased in comparison with the existing capacitor since the respective capacitance generation parts 120 and 220 are respectively formed on separate substrates.

In addition, in the case of the thin film silicon capacitor in which a plurality of MIM layers are stacked on a single substrate, the MIM layers on a lower part thereof are subjected to repetitive heat treatments in the processing procedure. The repetitive heat treatments may deteriorate capacitor electrode and dielectric layer characteristics.

Whereas, according to the present embodiment of the invention, since the capacitance generation parts 120 and 220 are respectively formed on the separate substrates, the amount of heat treatments performed on the respective capacitance generation parts 120 and 220 may be decreased.

Therefore, the capacitor according to the present embodiment of the invention is less likely to have deterioration in electrode layer and dielectric layer characteristics.

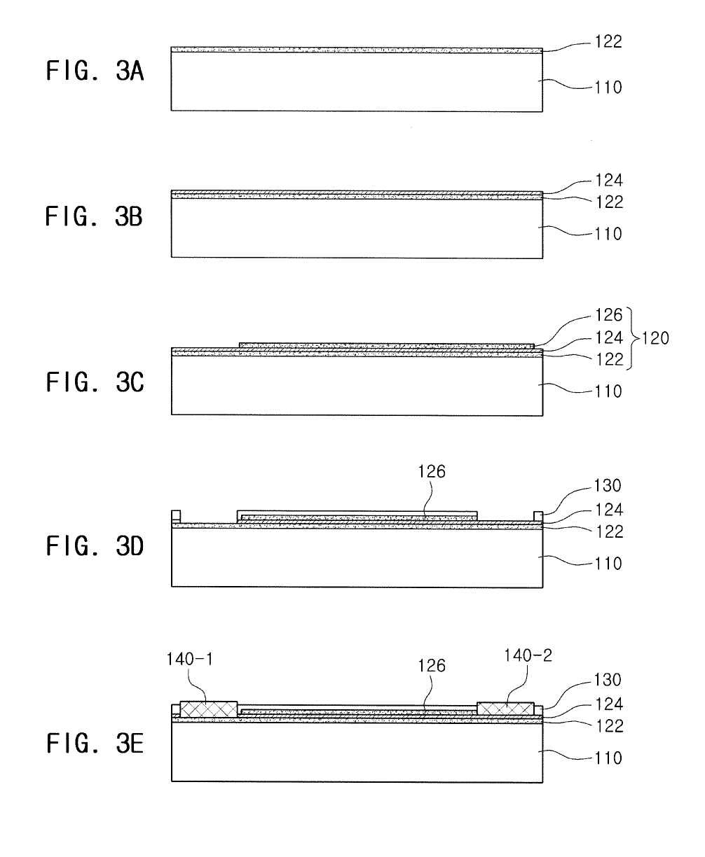

FIGS. 3A to 3E are views illustrating a method of manufacturing a first structure body according to another embodiment of the present invention.

According to the present embodiment of the invention, a first substrate 110 may be prepared.

In addition, a first lower electrode 122 maybe formed on one surface of the first substrate 110 (FIG. 3A).

In addition, a first dielectric layer 124 maybe formed on one surface of the first lower electrode 122 (FIG. 3B).

Here, the first dielectric layer 124 may be formed by physical vapor deposition (PVD) such as sputtering or the like, chemical vapor deposition (CVD), atomic layer deposition (ALD), chemical solution deposition (CSD) using sol-gel, or the like.

In addition, a first upper electrode 126 maybe formed on one surface of the first dielectric layer 124 (FIG. 3C).

The first lower electrode 122, the first dielectric layer 124, and the first upper electrode 126 may be commonly called a first capacitance generation part 120.

In addition, a first protective layer 130 maybe formed on one surface of the first capacitance generation part 120 (FIG. 3D).

According to the present embodiment of the invention, first electrode pad parts 140 may be formed on one surface of the first substrate 110.

The first electrode pad part 140 may include a first connection part 140-1 and a second connection part 140-2.

The first connection part 140-1 may be electrically connected to the first lower electrode 122 or the first upper electrode 126.

When the first connection part 140-1 is electrically connected to the first lower electrode 122, the second connection part 140-2 may be electrically connected to the first upper electrode 126 (FIG. 3E).

Alternatively, when the first connection part 140-1 is electrically connected to the first upper electrode 126, the second connection part 140-2 may be electrically connected to the first lower electrode 122.

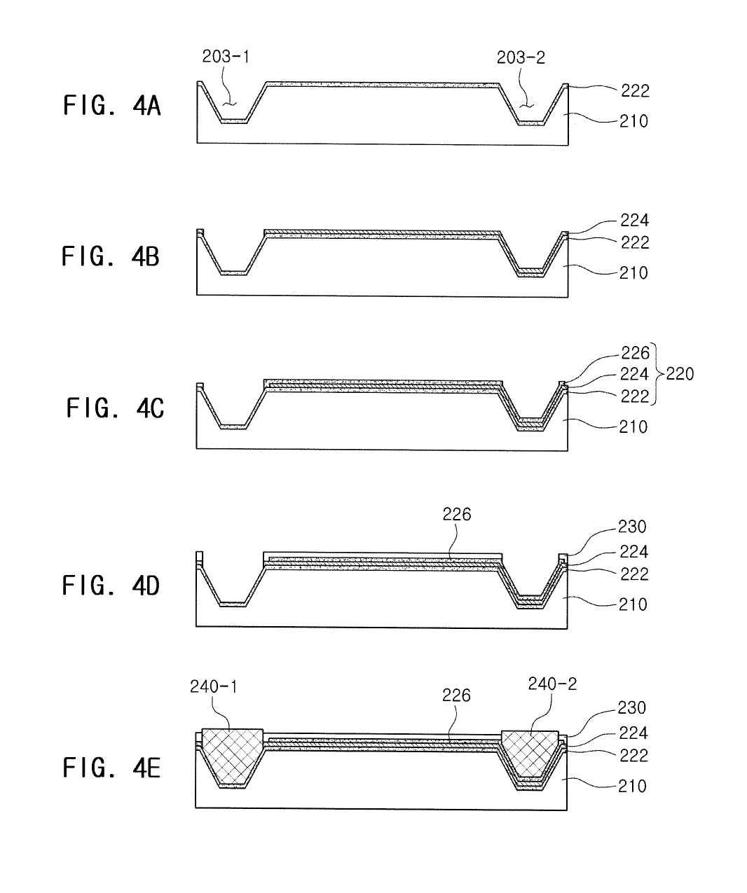

FIGS. 4A to 4E are views illustrating a method of manufacturing a second structure body according to another embodiment of the present invention.

According to the present embodiment of the invention, a second substrate 210 may be prepared.

In addition, the second substrate 210 may include a plurality of second electrode pad forming portions 203-1 and 203-2. For example, depressed regions in which second electrode pad parts are to be formed may be formed in the second substrate 210. The depressed regions 203-1 and 203-2 may be formed in positions corresponding to the first and second connection parts 140-1 and 140-2 of the first substrate 110.

In addition, a second lower electrode 222 may be formed on one surface of the second substrate 210 (FIG. 4A).

In addition, a second dielectric layer 224 may be formed on one surface of the second lower electrode 222 (FIG. 4B).

The second dielectric layer 224 may be formed by physical vapor deposition (PVD) such as sputtering or the like, chemical vapor deposition (CVD), atomic layer deposition (ALD), a chemical solution deposition (CSD) using sol-gel, or the like.

In addition, a second upper electrode 226 may be formed on one surface of the second dielectric layer 224 (FIG. 4C).

The second lower electrode 222, the second dielectric layer 224, and the second upper electrode 226 may be commonly called a second capacitance generation part 220.

In addition, a second protective layer 230 may be formed on one surface of the second capacitance generation part 220 (FIG. 4D).

According to the present embodiment of the invention, second electrode pad parts 240 may be formed on one surface of the first substrate 210. For example, the second electrode pad parts 240 may be formed in the depressed regions 203-1 and 203-2 formed in the substrate.

The second electrode pad parts 240 may include a third connection part 240-1 and a fourth connection part 240-2.

The third connection part 240-1 may be electrically connected to the second lower electrode 222 or the second upper electrode 226.

When the third connection part 240-1 is electrically connected to the second lower electrode 222, the fourth connection part 240-2 may be electrically connected to the second upper electrode 226 (FIG. 4E).

Alternatively, when the third connection part 240-1 is electrically connected to the second upper electrode 226, the fourth connection part 240-2 maybe electrically connected to the second lower electrode 222.

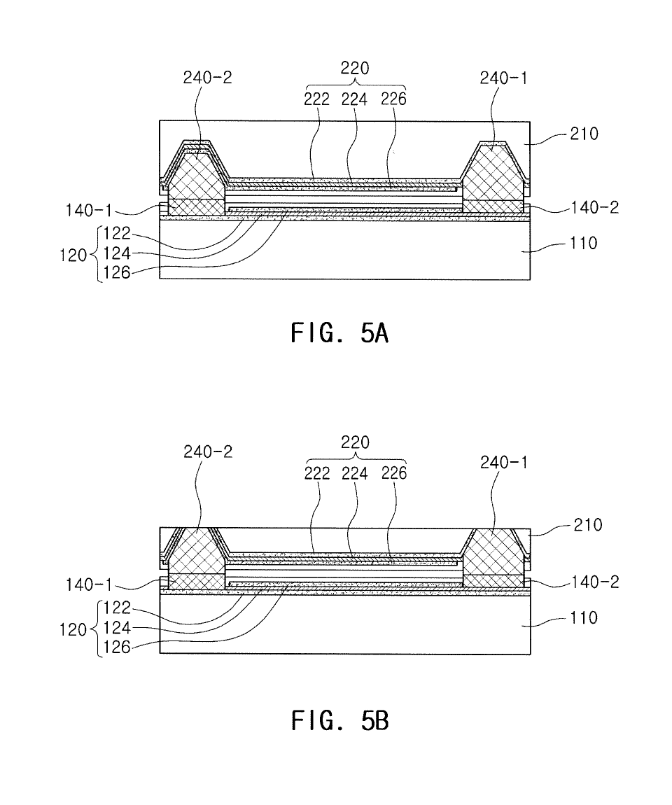

FIGS. 5A and 5B are views illustrating a method of manufacturing a capacitor according to another embodiment of the present invention.

According to the present embodiment of the invention, a second structure body 200 may be bonded to an upper surface of a first structure body 100 (FIG. 5A).

Here, a third connection part 240-1 and a fourth connection part 240-2 of second electrode pad parts 240 of the second structure body 200 may be disposed in positions corresponding to a first connection part 140-1 and a second connection part 140-2 of first electrode pad parts 140 of the first structure body 100.

Therefore, the second electrode pad parts 240 may be respectively bonded to one surfaces of the first electrode pad parts 140. The binding between the first electrode pad parts 140 and the second electrode pad parts 240 maybe performed by metal-metal binding. In addition, the first electrode pad parts 140 maybe electrically connected to the second electrode pad parts 240.

For example, the respective binding of the second electrode pad parts 240 to one surfaces of the first electrode pad parts 140 may include; binding the first connection part 140-1 and the third connection part 240-1 to each other; and binding the second connection part 140-2 and the fourth connection part 240-2 to each other.

Alternatively, the binding of the second electrode pad parts 240 to the first electrode pad parts 140 may include; binding the first connection part 140-1 and the fourth connection part 240-2 to each other; and binding the second connection part 140-2 and the third connection part 240-1 to each other (FIG. 5A).

Here, an empty space may be present between a first protective layer 130 and a second protective layer 230.

Meanwhile, the first protective layer 130 of the first structure body 100 and the second protective layer 230 of the second structure body 200 maybe bonded to each other, and thus integrated with each other.

The empty space may be present between the first protective layer 130 and the second protective layer 230 depending on the heights of the first electrode pad part 140 and the second electrode pad part 240, or the first protective layer 130 and the second protective layer 230 maybe bonded to each other, and thus integrated with each other.

According to the present embodiment of the invention, since the first electrode pad part 140 of the first structure body 100 and the second electrode pad part 240 of the second structure body 200 are directly bonded to each other, it is unnecessary to form separate electrodes.

In addition, as the binding surface between the first electrode pad part 140 and the second electrode pad part 240 is widened, a reduction in resistance inside the capacitor and an increase in yield thereof may be realized.

According to the present embodiment of the invention, one surface of the second structure body 200 may be ground (FIG. 5B). For example, one surface of the second structure body 200 may be subjected to grinding. The capacitor may be thinner through the grinding.

In the case in which one surface of the second structure body 200 is ground, the second electrode pad parts 240 may be exposed. The exposed electrode pad parts may be connected to an external circuit. Alternatively, another capacitance generation part may be formed on the exposed electrode pad parts.

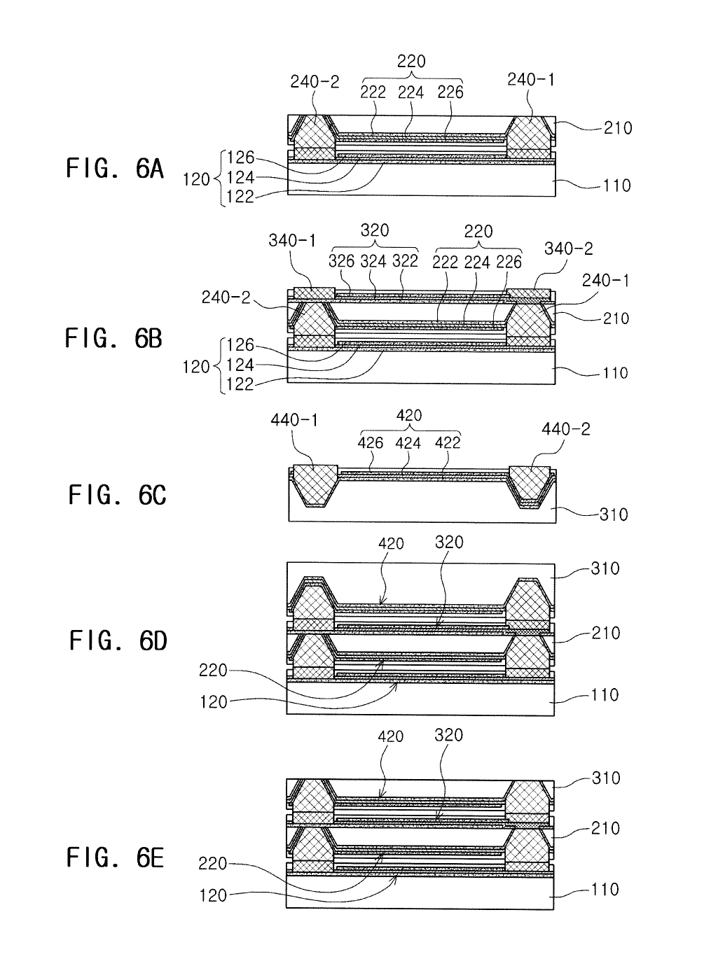

FIGS. 6A to 6E are views illustrating a method of manufacturing a capacitor according to another embodiment of the present invention.

Referring to FIG. 6A to 6E, a capacitor including a plurality of capacitance generation parts may be manufactured by three or more substrates 110, 210, and 310.

Referring to FIG. 6A, a capacitor including two substrates 110 and 120 and two capacitance generation parts 120 and 220 as shown in FIG. 5A may be prepared.

Referring to FIG. 6B, a third lower electrode 322, a third dielectric layer 324, and a third upper electrode 326 may be formed on a ground surface of the second structure body.

The third lower electrode 322 may be electrically connected to the third connection part 240-1 or the fourth connection part 240-2.

When the third lower electrode 322 is electrically connected to the fourth connection part 240-2, the third upper electrode 326 may be electrically connected to the third connection part 240-1.

Alternatively, when the third lower electrode 322 is electrically connected to the third connection part 240-1, the third upper electrode 326 maybe electrically connected to the fourth connection part 240-2.

The third lower electrode 322, the third dielectric layer 324, and the third upper electrode 326 may be commonly called a third capacitance generation part 320.

In addition, a third protective layer 330 may be formed on one surface of the third capacitance generation part 320.

According to the present embodiment of the invention, third electrode pad parts 340 may be formed on one surface of the second substrate 210.

The third electrode pad parts 340 may include a fifth connection part 340-1 and a sixth connection part 340-2.

The fifth connection part 340-1 may be electrically connected to the third lower electrode 322 or the third upper electrode 326.

When the fifth connection part 340-1 is electrically connected to the third lower electrode 322, the sixth connection part 340-2 may be electrically connected to the third upper electrode 326.

Alternatively, when the fifth connection part 340-1 is electrically connected to the third upper electrode 326, the sixth connection part 340-2 may be electrically connected to the third lower electrode 322.

An upper surface of the bonded body in which the third capacitance generation part 320, the third protective layer 330, and the third electrode pad part 340 are formed is similar to an upper surface of the first structure body 100. Therefore, another substrate and capacitance generation part may be stacked by employing the method in which the second structure body 200 is bonded to the upper surface of the first structure body 100 in the same manner.

Referring to FIG. 6C, a third structure body shown in FIG. 4E may be prepared.

Referring to FIG. 6D, the third structure body may be bonded to one surface of the bonded body shown in FIG. 6B, to thereby manufacture a capacitor including three substrates 110, 210, and 310 and four capacitance generation parts 120, 220, 320, and 420.

Referring to FIG. 6E, one surface of the bonded body may be subjected to grinding by the method explained in FIG. 5B.

By the above-mentioned method, a capacitor including a plurality of capacitance generation parts formed by stacking a plurality of substrates may be manufactured.

Since a plurality of capacitance generation parts are mounted on a single substrate in the existing capacitor, the number of capacitance generation parts mounted per substrate needs to be relatively large.

Whereas, according to an embodiment of the present invention, the number of capacitance generation parts mounted per substrate may be decreased.

As the number of capacitance generation parts mounted on a single substrate is increased, surface roughness becomes accumulated, and thus the number of times of heat treatment applied to the capacitance generation part in a lower part of the capacitor is increased. As described above, the accumulation of surface roughness causes current leakage, and the increased number of times of heat treatment causes deterioration in electrode layer and dielectric layer characteristics.

In the capacitors according to the embodiments of the invention, the number of capacitance generation parts mounted per substrate may be decreased. Therefore, in the capacitors according to the embodiments of the invention, defects such as current leakage and deterioration in electrode layer and dielectric layer characteristics may be reduced.

As set forth above, according to an embodiment of the present invention, there can be provided a capacitor capable of preventing current leakage due to accumulation of surface roughness caused by stacking a plurality of MIM layers, and a method of manufacturing the same.

Further, there can be provided a capacitor capable of preventing deterioration in electrode layer and dielectric layer characteristics due to repetitive heat treatments, and a method of manufacturing the same.

While the present invention has been shown and described in connection with the embodiments, it will be apparent to those skilled in the art that modifications and variations can be made without departing from the spirit and scope of the invention as defined by the appended claims.

What is claimed is:

1. A capacitor, comprising:
a first substrate:
a first capacitance generation part formed on the first substrate;
a protective layer formed on the first capacitance generation part;
a second capacitance generation part formed on the protective layer; and
a second substrate formed on the second capacitance generation part.

2. The capacitor of claim 1, wherein the first capacitance generation part includes a first lower electrode, a first dielectric layer, and a first upper electrode.

3. The capacitor of claim 2, wherein the second capacitance generation part includes a second lower electrode, a second dielectric layer, and a second upper electrode.

4. The capacitor of claim 2, wherein the first and second lower electrodes and the first and second upper electrodes include at least one of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

5. The capacitor of claim 2, wherein the first and second dielectric layers include at least one of lead zirconium titanates (PZT, PLZT, PNZT), barium titanate (BTO), barium strontium titanate (BST), strontium titanium oxide (STO), lead titanate (PTO), antimony tin oxide (ATO), titanium dioxide (TiO₂), and tantalum oxide (Ta₂O₅), aluminum oxide (Al₂O₃), niobium oxide (Nb₂O₅), silicon nitride (Si₃N₄), and silicon dioxide (SiO₂).

6. The capacitor of claim 1, further comprising a third capacitance generation part formed on the second substrate.

7. The capacitor of claim 6, further comprising a third substrate formed on the third capacitance generation part.

8. The capacitor of claim 3, further comprising:
first electrode pad parts electrically connected to the first capacitance generation part; and
second electrode pad parts electrically connected to the second capacitance generation part,
wherein the first electrode pad parts and the second electrode pad parts are electrically connected to each other.

9. The capacitor of claim 8, wherein the first electrode pad parts include:
a first connection part electrically connected to one of the first lower electrode and the first upper electrode; and
a second connection part electrically connected to the other of the first lower electrode and the first upper electrode, not electrically connected to the first connection part.

10. The capacitor of claim 8, wherein the second electrode pad parts include:
a third connection part electrically connected to one of the second lower electrode and the second upper electrode; and
a fourth connection part electrically connected to the other of the second lower electrode and the second upper electrode, not electrically connected to the third connection part.

11. The capacitor of claim 8, wherein the second electrode pad parts are formed on the first electrode pad parts .

12. The capacitor of claim 8, wherein the first electrode pad parts and the second electrode pad parts are formed on the first substrate.

13. A method of manufacturing a capacitor, the method comprising:
preparing a first structure body including a first capacitance generation part, a first protective layer, and first electrode pad parts;
preparing a second structure body including a second capacitance generation part, a second protective layer, and second electrode pad parts; and
binding the second structure body to an upper surface of the first structure body by disposing the first electrode pad parts and the second electrode pad parts in positions corresponding to each other.

14. The method of claim 13, wherein the preparing of the first structure body includes:
preparing a first substrate;
forming a first capacitance generation part on one surface of the first substrate;
forming a first protective layer on an upper surface of the first capacitance generation part; and
forming first electrode pad parts on one surface of the first substrate.

15. The method of claim 13, wherein the preparing of the second structure body includes:
preparing a second substrate including depressed regions;
forming a second capacitance generation part on one surface of the second substrate;
forming a second protective layer on an upper surface of the second capacitance generation part; and
forming second electrode pad parts in the depressed regions of the second substrate.

16. The method of claim 13, wherein in the binding of the second structure body to the upper surface of the first structure body, the first electrode pad parts and the second electrode pad parts are electrically connected to each other.

17. The method of claim 15, further comprising grinding the second electrode pad parts formed in the depressed regions.

18. The method of claim 17, further comprising forming a third capacitance generation part, a third protective layer, and third electrode pad parts on a ground surface.
